(19) United States
(12) Patent Application Publication
(10) Pub. No.: US 2006/0206914 A1
(43) Pub. Date: Sep. 14, 2006

(54) Wireless television system and video display method thereof

(75) Inventor: Kun Kook Park, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/356,029

(22) Filed: Feb. 17, 2006

(30) Foreign Application Priority Data
Feb. 17, 2005 (KR) 10-2005-0013244

(51) Int. Cl. H04N 7/173

(52) U.S. Cl. 725/119; 725/131

(57) ABSTRACT

A wireless television system and a video display method thereof are disclosed. Data stored in a portable memory can be directly read through the use of a memory reader additionally provided in a data transmission unit of the wireless television system, and then transmitted wirelessly to a video display unit of the system. Any one of the data of the portable memory read by the memory reader of the data transmission unit and an A/V signal inputted through a cable or antenna can be more efficiently selected according to the user's desire and then displayed on the screen of the video display unit. Therefore, the user can simply and conveniently view the data stored in the portable memory using the wireless television system without connecting the portable memory to a PC or notebook computer. Further, the user can conveniently select moving image or still image data stored in the portable memory, resulting in a significant improvement in convenience of use.

### 1. TECHNICAL FIELD

The present invention relates to a wireless television system which is divided into a data transmission unit and a video display unit.

### 2. BACKGROUND ART

Local-area wireless interface means, such as Bluetooth, Wireless Fidelity (WiFi), Ultra Wide Band (UWB), and Wireless Local Area Network (WLAN), have been developed and commercially available.

The wireless interface means has a data rate high enough to transmit audio and video data, which leads to the development of data communication systems of various types using it.

For example, a wireless television system has been developed which is divided into a data transmission unit for transmitting data using the wireless interface means, and a video display unit for receiving the data transmitted from the data transmission unit using the wireless interface means and displaying the received data on the screen thereof.

Because a wire cable is not connected to the video display unit, the user can listen to and watch audio and video received from the data transmission unit by simply and conveniently moving the video display unit to a desired position within a communication distance of the wireless interface means.

Meanwhile, a personal computer (PC) or notebook computer may be equipped with the wireless interface means to perform data communication with the video display unit. Alternatively, the PC or notebook computer may be connected to the data transmission unit. In this case, the user can watch a moving image or still image stored in a hard disk drive (HDD) of the PC or notebook computer through the large screen of the video display unit.

However, in order to display moving image or still image data stored in the PC or notebook computer on the screen of the video display unit of the wireless television system, as stated above, the user has to connect the PC or notebook computer with the data transmission unit.

Further, the PC or notebook computer must be equipped with the wireless interface means, resulting in inconvenience of use. Furthermore, in order to display video data stored in a portable memory on the screen of the video display unit of the wireless television system, the user has the trouble of having to connect the portable memory to the PC or notebook computer.

FIG. 1 is a block diagram showing the configuration of a conventional wireless television system. As shown in this drawing, the wireless television system is divided into a data transmission unit 10 and a video display unit 20. The data transmission unit 10 includes a controller 101, an audio/video (A/V) processor 102, a Moving Picture Experts Group (MPEG) encoder 103, and a wireless interface module 104.

The A/V processor 102 processes a plurality of A/V signals inputted through a cable or antenna to output A/V data streams. The controller 101 controls the A/V processor 102 such that the A/V processor 102 selects and processes any one of the plurality of A/V signals. The MPEG encoder 103 encodes an A/V data stream from the A/V processor 102, corresponding to the selected and processed A/V signal, in an MPEG manner. The wireless interface module 104 transmits the MPEG-encoded data wirelessly.

In other words, the A/V processor 102 processes a plurality of A/V signals inputted through the cable or antenna to output A/V data streams that can be compression-encoded in the MPEG manner by the MPEG encoder 103. For example, the plurality of A/V signals may include an A/V signal of a television broadcast, and a playback A/V signal of a digital versatile disc (DVD).

The wireless interface module 104 may adopt a Bluetooth, WiFi, UWB or WLAN communication system, and functions to transmit the encoded data from the MPEG encoder 103 wirelessly to the video display unit 20. The video display unit 20 receives and decodes the wirelessly transmitted data, and then displays the decoded data as an image on the screen thereof.

However, in order to display data stored in a PC or notebook computer on the screen of the video display unit of the wireless television system, the user has the trouble of having to connect the PC or notebook computer to the data transmission unit of the wireless television system.

Moreover, in a place where there is no PC or notebook computer, it is impossible to display video data stored in a portable memory on the screen of the video display unit of the wireless television system.

### 3. DISCLOSURE OF INVENTION

Therefore, the present invention has been made in view of the above problems, and it is an object of the present invention to provide a wireless television system wherein data stored in a portable memory can be directly read through the use of a memory reader additionally provided in a data transmission unit of the wireless television system, and then transmitted wirelessly to a video display unit of the system.

It is another object of the present invention to provide a video display method of a wireless television system which is capable of more efficiently selecting any one of data of a portable memory read by a memory reader of a data transmission unit of the wireless television system and an A/V signal inputted through a cable or antenna according to the user's desire, and displaying the selected data or A/V signal on the screen of a video display unit of the system.

In accordance with an aspect of the present invention, the above and other objects can be accomplished by the provision of a wireless television system divided into a data transmission unit and a video display unit, wherein the data transmission unit comprises: means for connection with a portable memory; means for reading data stored in the portable memory; and means for transmitting the read data wirelessly to the video display unit.

The connection means may be a slot for connection with the portable memory, the reading means may be a memory reader for reading the data stored in the portable memory, and the transmitting means may be a wireless interface module adopting a wireless communication system, the wireless communication system being any one of a Bluetooth, Wireless Fidelity (WiFi), Ultra Wide Band (UWB) or Wireless Local Area Network (WLAN) communication system.

Preferably, the data transmission unit further comprises: means for temporarily storing still image data read from the portable memory; means for processing broadcast signals and external input signals to output audio/video (A/V) data streams; means for Moving Picture Experts Group (MPEG)—encoding an A/V data stream from the processing means; and means for controlling operations of the processing means and transmitting means.

The control means may control the operation of the transmitting means such that the transmitting means wirelessly transmits any one of the MPEG-encoded A/V data stream from the encoding means and the data read from the portable memory to the video display unit, and the encoding means may be an MPEG encoder for encoding the A/V data stream from the processing means into an MPEG2 transport stream.

Preferably, the video display unit comprises a decoder for decoding still image data of the portable memory wirelessly transmitted from the transmitting means, and the decoder may be a multiformat decoder for decoding still image data of at least one of Joint Photographic Coding Experts Group (JPEG), Graphics Interchange Format (GIF) and Audio Video Interleaving (AVI) formats.

In accordance with another aspect of the present invention, there is provided a video display method of a wireless television system, comprising the steps of: determining whether a portable memory has been connected to a data transmission unit; displaying a menu picture for selection of any one of an A/V signal of an external input and video data of the portable memory on a screen of a video display unit if the portable memory has been connected to the data transmission unit; and receiving the video data of the portable memory from the data transmission unit and displaying the received video data on the screen of the video display unit, if the video data of the portable memory is selected through the menu picture.

Preferably, the video display method further comprises the steps of: receiving the A/V signal of the external input from the data transmission unit and displaying the received A/V signal on the screen of the video display unit, if the portable memory has not been connected to the data transmission unit; and receiving the A/V signal of the external input from the data transmission unit and displaying the received A/V signal on the screen of the video display unit, if the video data of the portable memory is not selected through the menu picture.

Preferably, the step of receiving the video data of the portable memory and displaying the received video data on the screen of the video display unit comprises the steps of: requesting the data transmission unit to transmit a video data list of the portable memory to the video display unit; transmitting the video data list of the portable memory from the data transmission unit to the video display unit; receiving the video data list of the portable memory from the data transmission unit, displaying the received video data list on the screen of the video display unit and requesting the data transmission unit to transmit specific video data, selected in the video data list by a user, to the video display unit; transmitting the requested specific video data from the data transmission unit to the video display unit; and receiving the specific video data from the data transmission unit, decoding the received video data through a decoder of the video display unit and displaying the decoded data on the screen of the video display unit.

Preferably, the video display method further comprises the steps of: determining whether the user desires different video data, after decoding the specific video data through the decoder and displaying the decoded data on the screen of the video display unit; and requesting the data transmission unit to transmit the video data list of the portable memory to the video display unit, upon determining that the user desires the different video data.

### 4. BRIEF DESCRIPTION OF DRAWINGS

The above and other objects, features and other advantages of the present invention will be more clearly understood from the following detailed description taken in conjunction with the accompanying drawings, in which:

FIG. 1 is a block diagram showing the configuration of a conventional wireless television system;

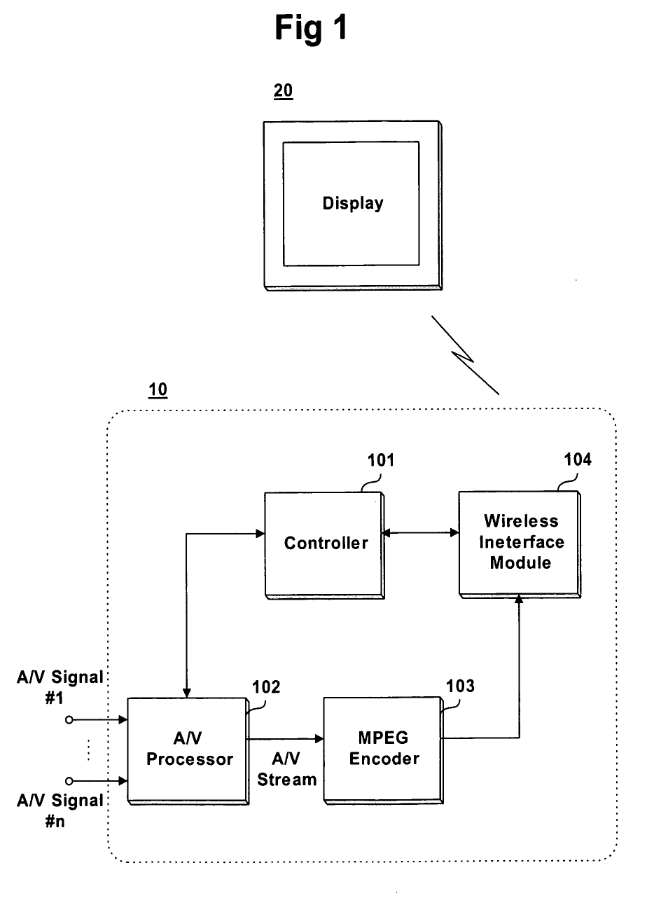

FIG. 2 is a block diagram showing the configuration of a wireless television system according to the present invention; and

FIG. 3 is a flow chart illustrating a video display method of the wireless television system according to the present invention.

### 5. MODES FOR CARRYING OUT THE INVENTION

Now, preferred embodiments of a wireless television system and a video display method thereof according to the present invention will be described in detail with reference to the annexed drawings.

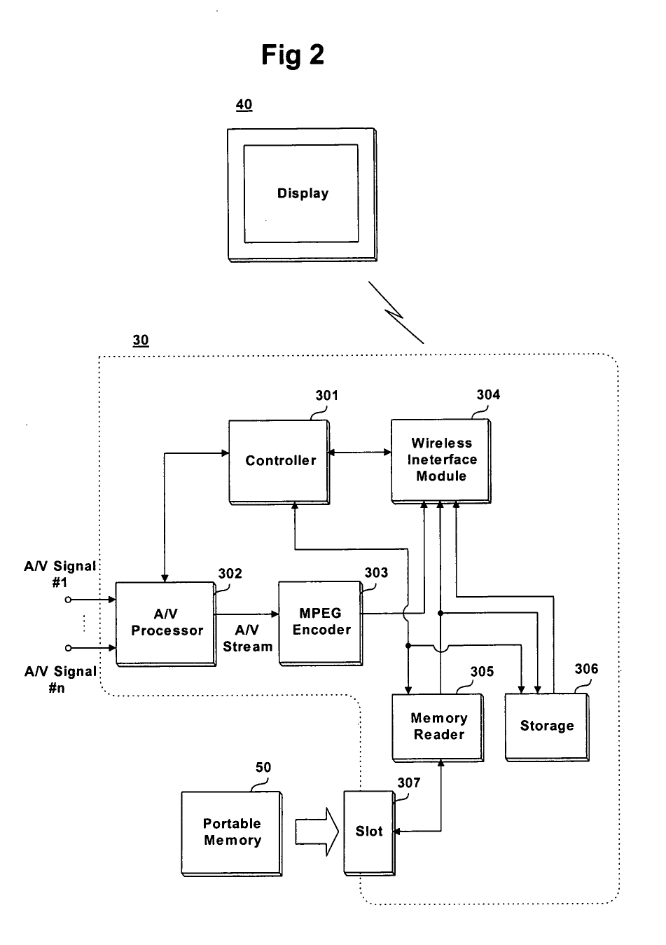

FIG. 2 is a block diagram showing the configuration of a wireless television system according to the present invention. As shown in this drawing, the wireless television system is divided into a data transmission unit 30 and a video display unit 40. The data transmission unit 30 includes a controller 301, an A/V processor 302, an MPEG encoder 303, and a wireless interface module 304.

The data transmission unit 30 further includes, as shown in FIG. 2, a memory reader 305, a storage 306 and a slot 307. A portable memory 50 is connected to the slot 307. The memory reader 305 directly reads moving image or still image data stored in the portable memory 50. The still image data read from the portable memory 50 is stored in the storage 306.

The controller 301 performs a control operation such that a plurality of A/V signals and the moving image or still image data of the portable memory 50 are selectively transmitted. The A/V processor 302 selects and processes any one of the plurality of A/V signals under the control of the controller 301 to output an A/V data stream. The MPEG encoder 303 compression-encodes the A/V data stream from the A/V processor 302 into an MPEG2 transport stream.

The memory reader 305 is connected with the portable memory 50 through the slot 307 to read the moving image or still image data stored in the portable memory 50 under the control of the controller 301. The storage 306 temporarily stores the still image data read by the memory reader 305 under the control of the controller 301.

The wireless interface module 304 selects any one of the MPEG2 transport stream encoded by the MPEG encoder 303, the moving image data of the portable memory 50 read by the memory reader 305 and the still image data temporarily stored in the storage 306 under the control of the controller 301, and transmits the selected one wirelessly to the video display unit 40.

Meanwhile, when the memory reader 305 is connected with the portable memory 50 through the slot 307, it outputs a corresponding signal to the controller 301. The controller 301 outputs a data read enable signal to the memory reader 305 in response to the output signal from the memory reader 305 such that the memory reader 305 reads data stored in the portable memory 50. Video data stored in the portable memory 50 can be classified into moving image data and still image data according to extension indexes.

The storage 306 temporarily stores the still image data read by the memory reader 305 under the control of the controller 301 and then repeatedly outputs the stored still image data to the wireless interface module 304.

For example, if the wireless interface module 304 transmits the still image data only once, a corresponding still image disappears after being instantaneously displayed on the screen of the video display unit 40, so that it cannot be accurately viewed by the user. For this reason, the still image data stored in the storage 306 is repeatedly outputted so that the still image can be displayed on the screen of the video display unit 40 continuously for a predetermined period of time.

On the other hand, for selection and display of a different still image responsive to the user's request, the controller 301 initializes the storage 306 and then stores a new still image selected by the user in the storage 306. The wireless interface module 304 performs wireless data communication with the video display unit 40, and receives a command transmitted from the video display unit 40 and transfers the received command to the controller 301.

The video display unit 40 receives data wirelessly transmitted from the data transmission unit 30 through a wireless interface module (not shown) thereof, decodes the received data through a decoder (not shown) thereof, and displays the decoded data as an image on the screen thereof. The video display unit 40 also functions to wirelessly transmit the user's command inputted through a user interface to the data transmission unit 30.

For example, the still image data of the portable memory 50 may be in various formats, such as Joint Photographic Coding Experts Group (JPEG), Graphics Interchange Format (GIF) and Audio Video Interleaving (AVI). In this regard, the video display unit 40 preferably adopts a multiformat decoder.

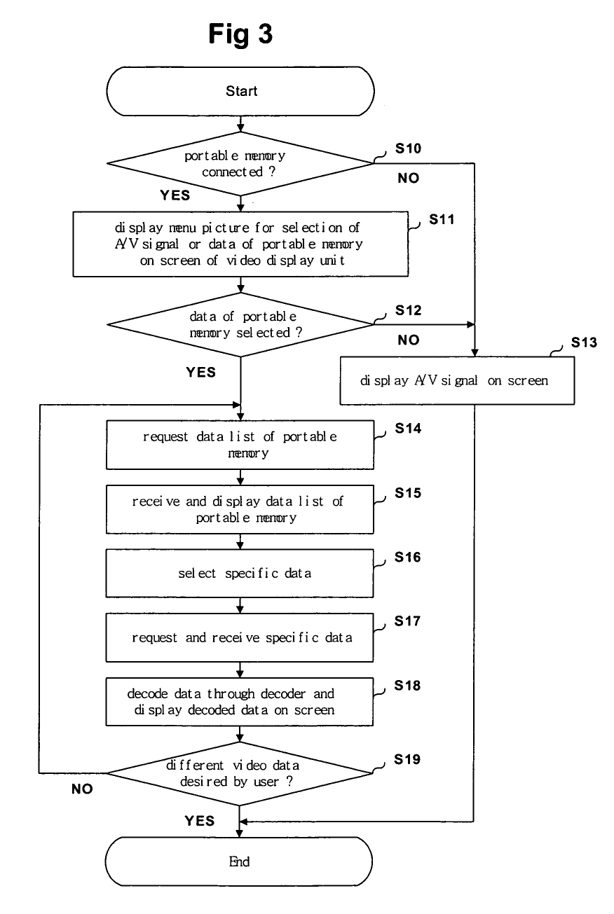

FIG. 3 is a flow chart illustrating a video display method of the wireless television system according to the present invention. As shown in this drawing, at step S10, a determination is made as to whether the portable memory 50 has been connected to the data transmission unit 30 through the slot 307. That is, if the memory reader 305 is connected with the portable memory 50 through the slot 307, it generates and outputs a corresponding signal to the controller 301.As a result, the controller 301 can determine, from the output signal from the memory reader 305, whether the portable memory 50 has been connected.

If the portable memory 50 is determined to have been connected at the above step S10, a menu picture for selection of any one of a plurality of A/V signals and data of the portable memory 50 is displayed on the screen of the video display unit 40 at step S11.

At step S12, a determination is made as to whether the user has selected the data of the portable memory 50 through the menu picture displayed at the above step S11. For example, if it is determined at step S12 that the data of the portable memory 50 has not been selected, or if it is determined at step S10 that the portable memory 50 has not been connected, an A/V signal of a television broadcast or a playback A/V signal of a DVD is displayed on the screen of the video display unit 40 at step S13.

On the contrary, in the case where it is determined at the above step S12 that the user has selected the data of the portable memory 50 through the menu picture, the video display unit 40 requests the data transmission unit 30 to transmit a list of video data stored in the portable memory 50, at step S14.

At step S15, the controller 301 controls the operation of the A/V processor 302 or wireless interface module 304 such that an A/V signal of a television broadcast or a playback A/V signal of a DVD is not transmitted wirelessly to the video display unit 40. The controller 301 then controls the operation of the memory reader 305 such that the list of the video data stored in the portable memory 50 is transmitted to the video display unit 40. The video display unit 40 receives the transmitted video data list and displays it on the screen thereof.

At step S16, the user selects desired specific video data in the video data list of the portable memory 50 displayed at the above step S15. At step S17, the video display unit 40 requests the data transmission unit 30 to transmit the specific video data selected by the user, and then receives the specific video data from the data transmission unit 30.

At this time, in the case where the specific video data selected by the user is moving image data, the data transmission unit 30 transmits moving image data of the portable memory 50 read by the memory reader 305 through the wireless interface module 304. However, in the case where the specific video data selected by the user is still image data, the data transmission unit 30 repeatedly transmits still image data of the portable memory 50 temporarily stored in the storage 306 through the wireless interface module 304.

At step S18, the video display unit 40 receives the specific video data, transmitted from the data transmission unit 30 in the above manner, decodes the received data through a decoder (not shown) thereof and displays the decoded data on the screen thereof. At step S19, a determination is made as to whether the user desires different video data. For example, if the user desires different moving image data or still image data, this method returns to the above step S14, at which the video display unit 40 carries out the wireless interface operation with the data transmission unit 30 to request it to transmit the video data list of the portable memory 50, and then performs the subsequent steps again.

As apparent from the above description, according to the wireless television system and the video display method thereof of the present invention, the user can simply and conveniently view data stored in a portable memory using the wireless television system without connecting the portable memory to a PC or notebook computer. Further, the user can conveniently select moving image or still image data stored in the portable memory, resulting in a significant improvement in convenience of use.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A wireless television system divided into a data transmission unit and a video display unit, wherein the data transmission unit comprises:
means for connection with a portable memory;
means for reading data stored in the portable memory; and
means for transmitting the read data wirelessly to the video display unit.

2. The wireless television system as set forth in claim 1, wherein the connection means is a slot for connection with the portable memory.

3. The wireless television system as set forth in claim 1, wherein the reading means is a memory reader for reading the data stored in the portable memory.

4. The wireless television system as set forth in claim 1, wherein the transmitting means is a wireless interface module adopting a wireless communication system, the wireless communication system being any one of a Bluetooth, Wireless Fidelity (WiFi), Ultra Wide Band (UWB) or Wireless Local Area Network (WLAN) communication system.

5. The wireless television system as set forth in claim 1, wherein the data transmission unit further comprises means for temporarily storing still image data read from the portable memory.

6. The wireless television system as set forth in claim 1, wherein the data transmission unit further comprises:
means for processing broadcast signals and external input signals to output audio/video (A/V) data streams;
means for Moving Picture Experts Group (MPEG)—encoding an A/V data stream from the processing means; and
means for controlling operations of the processing means and transmitting means.

7. The wireless television system as set forth in claim 6, wherein the control means controls the operation of the transmitting means such that the transmitting means wirelessly transmits any one of the MPEG-encoded A/V data stream from the encoding means and the data read from the portable memory to the video display unit.

8. The wireless television system as set forth in claim 6, wherein the encoding means is an MPEG encoder for encoding the A/V data stream from the processing means into an MPEG2 transport stream.

9. The wireless television system as set forth in claim 1, wherein the video display unit comprises a decoder for decoding still image data of the portable memory wirelessly transmitted from the transmitting means.

10. The wireless television system as set forth in claim 9, wherein the decoder is a multiformat decoder for decoding still image data of at least one of Joint Photographic Coding Experts Group (JPEG), Graphics Interchange Format (GIF) and Audio Video Interleaving (AVI) formats.

11. A video display method of a wireless television system, comprising the steps of:
determining whether a portable memory has been connected to a data transmission unit;
displaying a menu picture for selection of any one of an A/V signal of an external input and video data of the portable memory on a screen of a video display unit if the portable memory has been connected to the data transmission unit; and
receiving the video data of the portable memory from the data transmission unit and displaying the received video data on the screen of the video display unit, if the video data of the portable memory is selected through the menu picture.

12. The video display method as set forth in claim 11, further comprising the step of receiving the A/V signal of the external input from the data transmission unit and displaying the received A/V signal on the screen of the video display unit, if the portable memory has not been connected to the data transmission unit.

13. The video display method as set forth in claim 11, further comprising the step of receiving the A/V signal of the external input from the data transmission unit and displaying the received A/V signal on the screen of the video display unit, if the video data of the portable memory is not selected through the menu picture.

14. The video display method as set forth in claim 11, wherein the step of receiving the video data of the portable memory and displaying the received video data on the screen of the video display unit comprises the steps of:
requesting the data transmission unit to transmit a video data list of the portable memory to the video display unit;
transmitting the video data list of the portable memory from the data transmission unit to the video display unit;
receiving the video data list of the portable memory from the data transmission unit, displaying the received video data list on the screen of the video display unit and requesting the data transmission unit to transmit specific video data, selected in the video data list by a user, to the video display unit;
transmitting the requested specific video data from the data transmission unit to the video display unit; and
receiving the specific video data from the data transmission unit, decoding the received video data through a decoder of the video display unit and displaying the decoded data on the screen of the video display unit.

15. The video display method as set forth in claim 14, further comprising the step of determining whether the user desires different video data, after decoding the specific video data through the decoder and displaying the decoded data on the screen of the video display unit.

16. The video display method as set forth in claim 15, further comprising the step of requesting the data transmission unit to transmit the video data list of the portable memory to the video display unit, upon determining that the user desires the different video data.
